(19) United States
(12) Patent Application Publication
(10) Pub. No.: US 2024/0211777 A1
(43) Pub. Date: Jun. 27, 2024

(54) INFORMATION PROCESSING APPARATUS, INFORMATION PROCESSING METHOD, AND RECORDING MEDIUM

(71) Applicant: NEC Corporation, Tokyo (JP)

(72) Inventors: Takeru MATSUI, Tokyo (JP); Kazuhiko Toda, Tokyo (JP)

(73) Assignee: NEC Corporation, Tokyo (JP)

(21) Appl. No.: 18/543,185

(22) Filed: Dec. 18, 2023

(30) Foreign Application Priority Data
Dec. 23, 2022 (JP) 2022-207342

(51) Int. Cl. G06N 5/022

(52) U.S. Cl. CPC G06N 5/022

(57) ABSTRACT

An information processing apparatus includes a memory storing instructions; and one or more processors configured to execute the instructions to: acquiring failure factor information including a content of a failure that has occurred in a device, a failure factor of the failure, and a use situation of the device that causes the failure factor; predicting a use situation of a target device of a same type as the device installed in a facility based on information on a factor that affects a use situation of the target device; determining, based on the failure factor information, that the predicted use situation is a use situation that causes the failure factor; and notifying, according to a result of determination, failure prediction information indicating a possibility that a failure occurs in the target device.

This application is based upon and claims the benefit of priority from Japanese Patent Application No. 2022-207342, filed on Dec. 23, 2022, the disclosure of which is incorporated herein in its entirety by reference.

### TECHNICAL FIELD

The present disclosure relates to an information processing apparatus, an information processing method, and a recording medium storing a program.

### BACKGROUND ART

International Publication No. 2015/29301 discloses a technique of sharing failure information of home electric appliances of a predetermined model and presenting a user with a failure occurring in the same model by a threshold or more. International Publication No. 2015/29301 discloses a technique of presenting a possibility of occurrence of a failure by using information on a detected use situation and information indicating a use period of a device.

### SUMMARY

An object of the present disclosure is to predict a failure accurately.

An information processing apparatus according to an aspect of the present disclosure includes an acquisition means that acquires failure factor information including a content of a failure that has occurred in a device, a failure factor of the failure, and a use situation of the device that causes the failure factor, a use situation prediction means that predicts a use situation of a target device of a same type as the device installed in a facility based on information on a factor that affects a use situation of the target device, a determination means that determines, based on the failure factor information, that the predicted use situation is a use situation that causes the failure factor, and a notification means that notifies, according to a result of determination, failure prediction information indicating a possibility that a failure occurs in the target device.

In an information processing method according to an aspect of the present disclosure, a computer acquires failure factor information including a content of a failure that has occurred in a device, a failure factor of the failure, and a use situation of the device that causes the failure factor, predicts a use situation of a target device of a same type as the device installed in a facility based on information on a factor that affects a use situation of the target device, determines, based on the failure factor information, that the predicted use situation is a use situation that causes the failure factor, and notifies, according to a result of determination, failure prediction information indicating a possibility that a failure occurs in the target device.

A recording medium according to one aspect of the present disclosure stores an information processing program for causing a computer to execute processing of acquiring failure factor information including a content of a failure that has occurred in a device, a failure factor of the failure, and a use situation of the device that causes the failure factor, predicting a use situation of a target device of a same type as the device installed in a facility based on information on a factor that affects a use situation of the target device, determining, based on the failure factor information, that the predicted use situation is a use situation that causes the failure factor, and notifying, according to a result of determination, failure prediction information indicating a possibility that a failure occurs in the target device.

### BRIEF DESCRIPTION OF THE DRAWINGS

Exemplary features and advantages of the present disclosure will become apparent from the following detailed description when taken with the accompanying drawings in which:

FIG. 1 is a diagram illustrating a configuration of a system including an information processing apparatus;

FIG. 2 is a block diagram illustrating a functional configuration of the information processing apparatus;

FIG. 3 is a diagram illustrating an example of failure factor information;

FIG. 4 is a diagram illustrating a notification example;

FIG. 5 is a diagram illustrating a notification example;

FIG. 6 is a flowchart illustrating an operation of the information processing apparatus;

FIG. 7 is a diagram illustrating a configuration of a system including the information processing apparatus;

FIG. 8 is a block diagram illustrating a functional configuration of the information processing apparatus;

FIG. 9 is a diagram illustrating a notification example;

FIG. 10 is a flowchart illustrating an operation of the information processing apparatus; and

FIG. 11 is a diagram illustrating a hardware configuration in which the information processing apparatus according to the present disclosure is implemented by a computer device and its peripheral devices.

### EXAMPLE EMBODIMENT

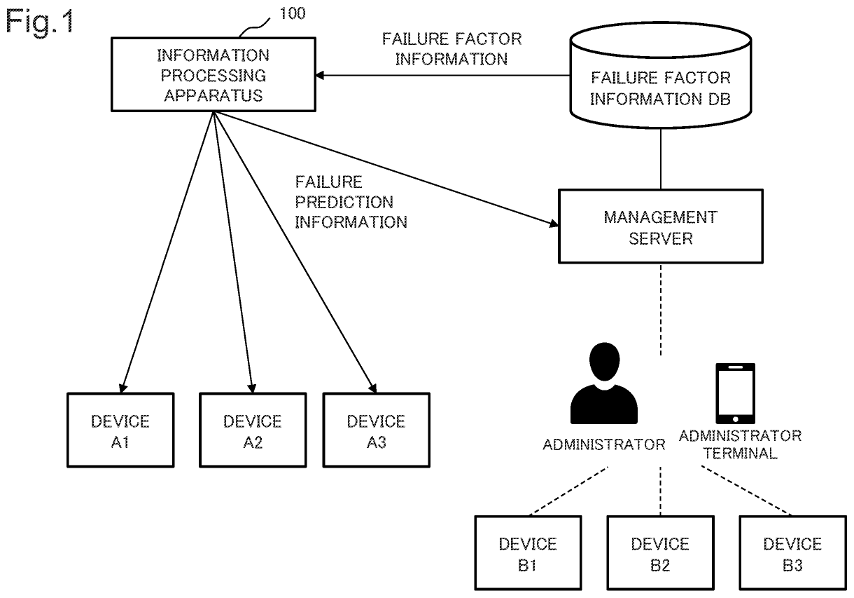

Next, a detailed explanation will be given for a first example embodiment with reference to the drawings. FIG. 1 is an exemplary block diagram showing the configuration of storage apparatus 200 of the first example embodiment.

Hereinafter, example embodiments of the present disclosure will be described in detail with reference to the drawings.

The present disclosure relates to a technique for predicting a failure of a device. An information processing apparatus, an information processing method, and a program according to the present disclosure predict a use situation of a device and predict a failure based on the predicted use situation.

The devices are machines and instruments. In the present disclosure, it is assumed that a device is provided in a facility. The facility is, for example, a store, a library, or a nursery school. Examples of the device include a refrigerator, a freezer, a heating chamber, a microwave oven, a flyer, a multifunction peripheral, a printer, and an air conditioner. The facility and the device are not limited to these examples. In the following example embodiment, an example of a device in a store such as a convenience store will be described, but the present disclosure is not limited to this example.

The failure means that the device cannot be used, the device cannot implement an expected function, or the device needs to be maintained or repaired. For example, the failure is that the temperature of the refrigerator or freezer does not reach the set temperature, that paper is not ejected from the printer, and the like.

A failure has a failure factor that causes the failure. The failure factor is, for example, wear, deterioration, damage, or the like of the device. The failure factor may be caused by a use situation including a manner of using the device, a use environment, and the like. That is, the use situation may indirectly cause a failure.

Hereinafter, a technique for predicting a failure of a device in the present disclosure will be described based on an example embodiment.

### First Example Embodiment

FIG. 1 is a diagram illustrating an example of a system including an information processing apparatus of the present disclosure.

In FIG. 1, an information processing apparatus 100 is an apparatus that predicts a failure of a device. The information processing apparatus 100 is communicably connected to a failure factor information database (hereinafter, it is also referred to as a failure factor information DB). The information processing apparatus 100 may be communicably connected to devices such as a device A1, a device A2, and a device A3 illustrated in FIG. 1. The information processing apparatus 100 may be connected to a target device to perform failure prediction via a management server of a facility or a management server that manages a group including the facility. The information processing apparatus 100 may not be communicably connected like a device B1, a device B2, and a device B3 illustrated in FIG. 1. As in the device B1, the device B2, and the device B3 illustrated in FIG. 1, information of the device may be managed by a management server of the facility or a management server that manages a group including the facility via an administrator terminal used by an administrator and an administrator of the facility or the device. The group including the facility is, for example, a group such as a company that manages the facility. Alternatively, in the information processing apparatus 100, in FIG. 1, the device A1, the device A2, the device A3, the device B1, the device B2, and the device B3 are described as devices, but the type and number of devices are not limited to this example. The connection between the information processing apparatus 100 and each apparatus is not limited to this example. The information processing apparatus 100 is only required to be connected to each device so as to be able to acquire the failure factor and further notify the apparatus, the administrator or the like who manages the device of the prediction of the failure.

The failure factor information DB is a database that stores failure factor information. The failure factor information is information in which at least one of a failure factor and a use situation that causes a failure factor is associated with a name or content indicating a failure. The failure factor information is generated based on, for example, failure information obtained from a device, a facility that manages the device, or a group that manages the facility. The failure information is information on a failure that has occurred. The failure information will be described in detail in a second example embodiment.

The failure factor information DB may be provided in the information processing apparatus 100.

Next, a configuration of the information processing apparatus 100 according to the example embodiment will be described.

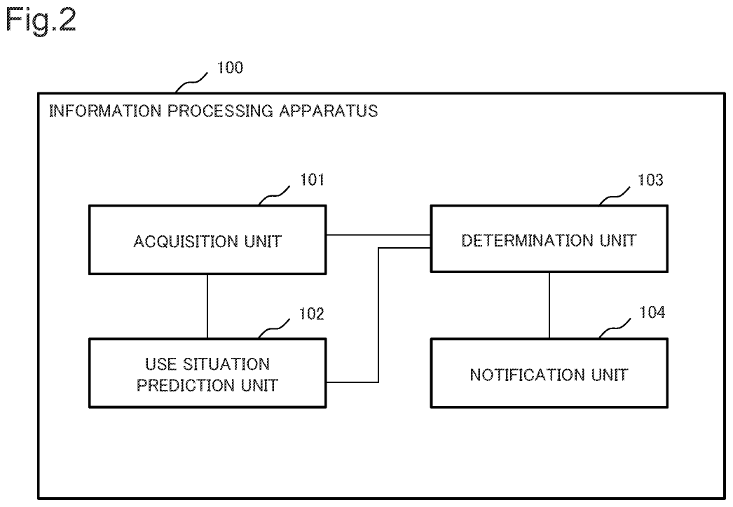

FIG. 2 is a block diagram illustrating a configuration of the information processing apparatus 100 in the first example embodiment. Referring to FIG. 2, the information processing apparatus 100 includes an acquisition unit 101, a use situation prediction unit 102, a determination unit 103, and a notification unit 104.

Next, a configuration of the information processing apparatus 100 according to the first example embodiment will be described in detail.

In FIG. 2, the acquisition unit 101 is an example of an acquisition means that acquires failure factor information including a content of a failure that has occurred in a device, a failure factor of the failure, and a use situation of the device that causes the failure factor. The acquisition unit 101 acquires the failure factor information from the failure factor information DB. Alternatively, the acquisition unit 101 may acquire the failure factor information from a failure factor analysis device that analyzes and specifies the failure factor. As described above, the failure factor information is information in which at least one of the failure factor and the use situation that causes the failure factor is associated with the name or content indicating the failure.

The use situation is information indicating a situation in which the device is used. The use situation includes, for example, a use environment, a use amount, and a number of times of use of the device. The use environment of the device is an environment around the operating device. The use environment of the device is, for example, temperature (room temperature), humidity, and sunlight. The use amount of the device is an amount by which the device is used. The number of times of use of the device is the number of times by which the device is used. The number of times of use of the device may be the number of times of use in a predetermined period, that is, the use frequency. The definition of the use of the device may be made for each device. For example, the use amount in the flyer may be the time that has been heated. The number of times of use in the fryer may be the number of fried products or the number of times heating is started. For example, the use amount in the refrigerator may be the weight of the product in the refrigerator or the number of products in the refrigerator. The number of times of use in the refrigerator may be the number of times of opening and closing the door.

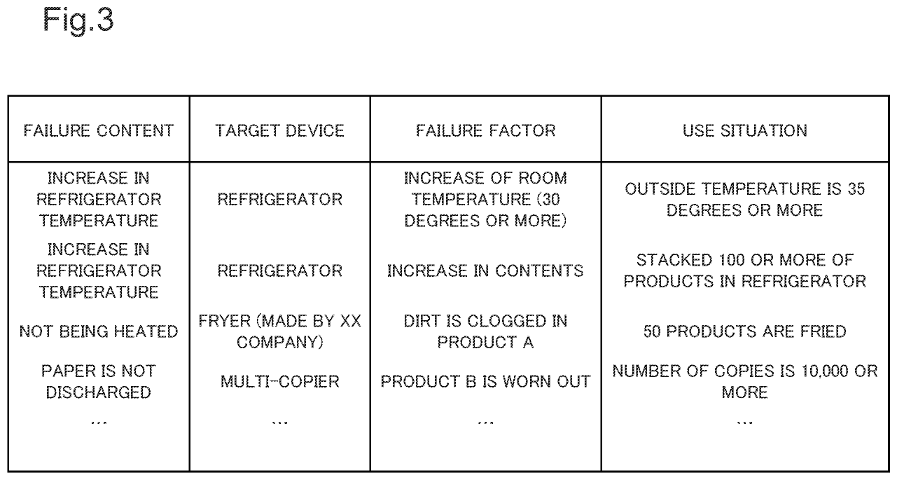

FIG. 3 is an example of failure factor information. In FIG. 3, the failure factor information includes a failure content indicating a content of a failure, a target device in which a failure occurs, a failure factor, and a use situation. In the failure factor information, a plurality of failure factors and a plurality of use situations may be associated with a certain failure content. When there are a plurality of failure factors or use situations, it may be set as a failure factor or use situation that the plurality of failure factors or use situations applies to all of them, or it may be set as a failure factor or use situation that either of them applies. The failure factor information may include at least one of a failure factor and a use situation for a certain failure content. In the following description of the example embodiment, since the use situation is used for the processing of the information processing apparatus 100, the information processing apparatus 100 is only required to perform the processing for the failure factor information associated with the use situation. For example, when the failure factor information is managed for each device, the failure factor information DB may not include the target device in which the failure has occurred. Alternatively, the failure content may include the target device. The information indicating the target device is not particularly limited. The information indicating the target device is, for example, a type (refrigerator, flyer, multi-copier, etc.) of the target device, a type and a manufacturer (in FIG. 3, it is represented as a flyer (manufactured by XX Corporation)) of the target device, a series or a model number of the target device, a lot number of the target device, or the like. The information indicating the target device indicates a range of the target device in which the failure indicated in the failure content occurs. The range of the target device may be appropriately set according to the failure content or the failure factor.

The use situation prediction unit 102 is an example of a use situation prediction means that predicts the use situation of the target device of the same type as the device installed in the facility based on the information on the factor affecting the use situation of the target device. The target device of the same type is a device included in the information indicating the target device included in the failure factor information. The range of the same type in the target device may be determined according to the failure factor in units such as a type (refrigerator, flyer, multi-copier, etc.) of the target device, a manufacturer of the target device, a series or a model number of the target device, and a lot number of the target device. The use situation prediction unit 102 determines a target device whose use situation is predicted from information indicating the target device included in the failure factor information. Then, the use situation prediction unit 102 acquires information on a factor that affects the use situation of the target device to be predicted. The information on the factor affecting the use situation is, for example, information on a facility in which the target device is installed. Amore specific example of the information on the factor affecting the use situation will be described later.

An example in which the use situation prediction unit 102 predicts the use environment will be described. The use situation prediction unit 102 predicts a use environment indicating an environment in which the target device is used among the use situations of the target devices based on weather information. The weather information is information indicating weather predicted in an area including a facility in which the target device is installed. The weather information is, for example, temperature, humidity, or sunshine hours.

Specifically, the use situation prediction unit 102 acquires the weather information of the area from the information indicating the area including the facility in which the target device is installed. The information indicating the area including the facility is, for example, an address. The use situation prediction unit 102 refers to information indicating a relationship between the weather information and the use environment, and predicts the use environment from the weather information.

In this case, the failure factor information includes information indicating a use environment in which the device is used as the use situation of the device that causes the failure factor. The information on the factor affecting the use situation of the target device is weather information of an area including a facility in which the target device is installed.

Next, an example in which the use situation prediction unit 102 predicts the number of times of use or the use amount will be described. In this case, it is assumed that the facility is a store. The use situation prediction unit 102 predicts the number of times of use or the use amount of the target device among the use situations of the target device based on the information indicating the sales prediction of the facility. The information indicating the sales prediction of the facility is another example of the information on the factor affecting the use situation of the target device. The information indicating the sales prediction of the facility is, for example, information indicating a prediction of the sales of the facility predicted from past sales data, sales data of another store, arrival information of goods, event information around the facility, weather information around the facility, and the like. The sales data is information indicating sales in a past predetermined period. The information indicating the sales prediction of the facility may be predicted by the use situation prediction unit 102 or another device.

An example in which the use situation prediction unit 102 predicts the sales of the facility will be described. For example, the use situation prediction unit 102 generates information indicating a sales prediction of the facility based on the sales data. The use situation prediction unit 102 may predict the sales of the facility by a known method. The use situation prediction unit 102 may predict the sales of the product related to the target device in the facility using the sales data of only the product related to the target device. The sales data may be point of sales (POS) data obtained in a POS system. In this case, the sales data or the POS data is another example of the information on the factor affecting the use situation of the target device. The use situation prediction unit 102 predicts the sales of the facility based on the sales data, and predicts the number of times of use or the use amount of the target device among the use situations of the target device based on the predicted sales.

Specifically, the use situation prediction unit 102 specifies a product related to the target device. For example, the use situation prediction unit 102 may specify the product related to the target device by referring to information stored in advance and associating the device with the product related to the device. The product related to the device is a beverage in the case of a refrigerator, a frozen food such as ice in the case of a freezer, or a hot snack fried in the store in the case of a flyer. There may be a plurality of types of products related to the target device. Next, the use situation prediction unit 102 extracts sales data of related products from the POS data. Alternatively, the use situation prediction unit 102 extracts data indicating the number of related products purchased from the data indicating the past number of purchases of the store. The data indicating the number of purchases is another example of information on a factor affecting the use situation of the target device. The use situation prediction unit 102 predicts the sales or the number of purchases of the product in a predetermined future period based on the extracted past sales data or data indicating the number of purchases. Then, the use situation prediction unit 102 predicts the number of times of use or the use amount of the target device by referring to information stored in advance, in which the number of purchases of the product is associated with the number of times of use or the use amount of the target device, or information stored in advance, in which the number of purchases of the product is associated with the number of times of use or the use amount of the target device.

As another example, the use situation prediction unit 102 may predict the number of payments in the store based on the sales data. The use situation prediction unit 102 extracts the number of times of payment from the sales data. The use situation prediction unit 102 predicts the number of times of payment in a future predetermined period based on the number of times of payment in the past. Then, the use situation prediction unit 102 may predict the predicted number of times of payment in a future predetermined period as the number of times of use of the printer that issues the receipt, which is the target device.

The use situation prediction unit 102 may predict the use situation included in the failure factor information among the use situations of the target device.

The determination unit 103 is an example of a determination means that determines, based on the failure factor information, that the predicted use situation is a use situation that causes a failure factor. As an example, the determination unit 103 refers to the failure factor information to determine whether the use situation predicted by the use situation prediction unit 102 applies to the use situation included in the failure factor information. That the use situation predicted by the use situation prediction unit 102 applies to the use situation included in the failure factor information means that the predicted use situation is included in the use situation included in the failure factor information. In a case where the predicted use situation is represented by a numerical range, the determination unit 103 may determine that the predicted use situation is applicable when at least a part of the predicted use situation matches the failure factor information.

When the determination unit 103 determines that the use situation predicted by the use situation prediction unit 102 applies to the use situation included in the failure factor information, it is predicted that there is a high possibility that a failure will occur in the target device. In a case where the determination unit 103 determines that the use situation predicted by the use situation prediction unit 102 does not apply to the use situation included in the failure factor information, it is predicted that no failure caused by the use situation and the associated failure factor will occur in the target device, or that the possibility that a failure caused by the use situation and the associated failure factor will occur is low. Alternatively, in a case where the determination unit 103 determines that the use situation predicted by the use situation prediction unit 102 does not apply to the use situation included in the failure factor information, it is predicted that there is a low possibility that a failure caused by the use situation and the associated failure factor will occur in the target device.

That is, the determination unit 103 predicts that there is a possibility that a similar failure will occur in a device in a use situation similar to the use situation of the device in which the failure has occurred, indicated by the failure factor information. This is to predict that, for example, in a case where there are many failures that the heating performance of a fryer frying 3000 products is deteriorated, there is a high possibility that a similar failure that the heating performance of the fryer is deteriorated will occur in the future when the number of products fried in another fryer reaches 3000. For example, in a case where there are many failures that a door of a refrigerator manufactured by a company that has been opened and closed 10,000 times is often damaged, it is predicted that there is a high possibility that a similar failure in which the door is damaged will occur when the number of times the door of another refrigerator manufactured by the company is opened and closed reaches 10,000 times in the future.

The notification unit 104 is an example of a notification means that notifies failure prediction information indicating the possibility that a failure occurs in the target device according to the determination result. The failure prediction information is information on failure prediction. The failure prediction information is information indicating that occurrence of a failure is predicted. The failure prediction information may be information indicating that the occurrence of a failure is not predicted.

The notification unit 104 notifies the output device included in the device, the terminal device of the facility that manages the device, the terminal device of the group that manages the facility, and the like of the failure prediction information. That is, the notification unit 104 may directly or indirectly notify a person who manages the device of the failure prediction information. In a case where the notification unit 104 notifies the terminal device of the facility managing the device or the terminal device of the group managing the facility, information instructing the administrator of the device to perform notification may be further notified in addition to the failure prediction information.

As described above, when the determination unit 103 determines that the use situation predicted by the use situation prediction unit 102 applies to the use situation included in the failure factor information, the notification unit 104 notifies the target device of information indicating that the occurrence of a failure is predicted. For example, in a case where the determination result indicates that the predicted use situation is the use situation that causes the failure factor, the notification unit 104 notifies the target device of information indicating that the occurrence of a failure is predicted according to the determination result.

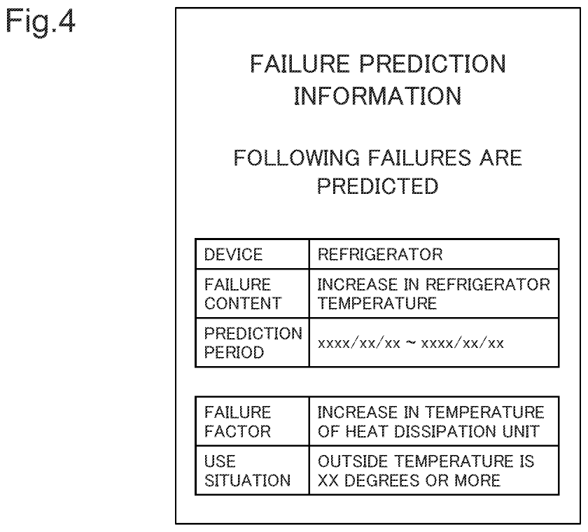

FIG. 4 is a notification example of information indicating that the occurrence of a failure is predicted in the target device. In FIG. 4, a notification example of the information indicating that the occurrence of a failure is predicted in the target device includes the information indicating that the failure is predicted, the target device, a failure content, a period in which the failure is predicted, a failure factor, and a use situation. The prediction period is a period in which occurrence of a failure is predicted. That is, the prediction period is a period in which it is determined that the predicted use situation applies to the use situation included in the failure factor information. In this case, the notification unit 104 notifies, as the failure prediction information, the determined prediction period included in the determination result, and the failure content, the failure factor, and the use situation included in the failure factor information used for the determination.

The information indicating that the occurrence of a failure is predicted in the target device may include a countermeasure for preventing or alleviating the occurrence of a failure. The countermeasure may be stored in association with each failure included in the failure factor information, or may be stored in association with a failure in another database. In a case where a countermeasure is included in the failure prediction information, the notification unit 104 may extract a countermeasure associated with the failure from the failure prediction information or another database and include the countermeasure in the failure prediction information for notification.

When the determination unit 103 determines that the use situation predicted by the use situation prediction unit 102 does not apply to the use situation included in the failure factor information, the notification unit 104 may notify the target device of information indicating that the occurrence of a failure is not predicted. The fact that the occurrence of a failure in the target device is not predicted means that the possibility of the occurrence of a failure is predicted to be low. For example, in a case where the determination result indicates that the predicted use situation is not the use situation that causes the failure factor, the notification unit 104 may notify the target device of information indicating that the occurrence of a failure is not predicted according to the determination result.

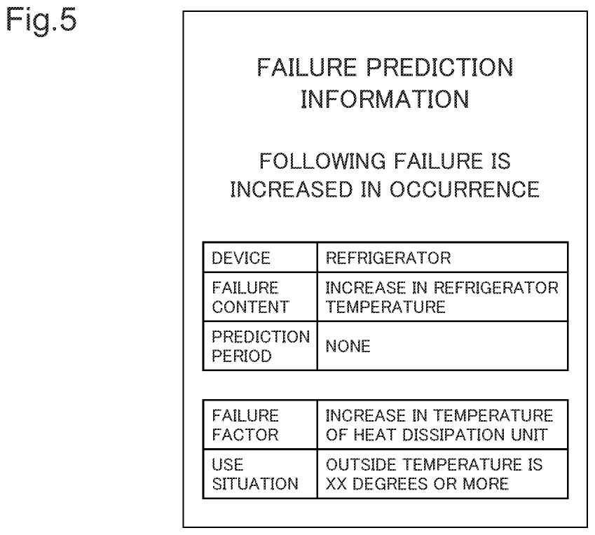

FIG. 5 is a notification example of information indicating that the occurrence of a failure is not predicted in the target device. In FIG. 5, the fact that the failure prediction period is indicated as “none” indicates that the occurrence of a failure has not been predicted, that is, the possibility of the occurrence of a failure is low. On the other hand, in the example of FIG. 4 in which the possibility of the occurrence of a failure is predicted to be high, the prediction period is illustrated. In FIG. 5, the notification example of the information indicating that the occurrence of a failure is not predicted in the target device includes the information indicating that the failure increases, the target device, the failure content, the absence of the period in which the failure is predicted, the failure factor, and the use situation. By notifying the target device even when the occurrence of a failure is not predicted, the administrator or the like of the device can recognize the possibility of the occurrence of a failure when the use situation deviates from the prediction.

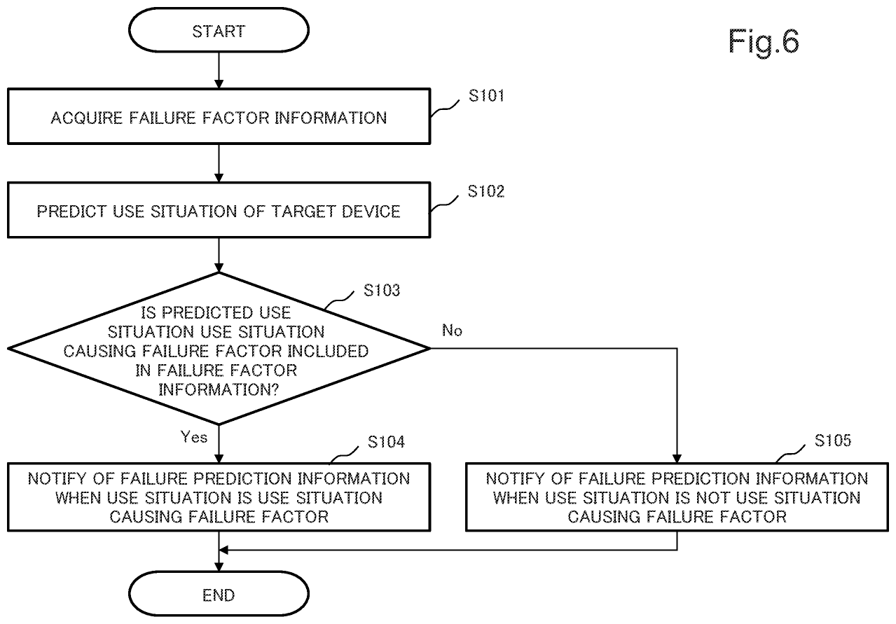

The operation of the information processing apparatus 100 configured as described above will be described with reference to the flowchart of FIG. 6.

FIG. 6 is a flowchart illustrating an example of the operation of the information processing apparatus 100 according to the first example embodiment.

As illustrated in FIG. 6, first, the acquisition unit 101 acquires failure factor information (step S101). The acquisition unit 101 may acquire the failure factor information at any time or at regular intervals such as every day, every half day, and every week. The acquisition unit 101 may compare the failure factor information acquired last time with the failure factor information stored in the failure factor information DB of the acquisition destination and acquire only a difference therebetween.

Next, the use situation prediction unit 102 predicts the use situation of the target device included in the failure factor information (step S102). The use situation prediction unit 102 may predict the use situation of the target device included in the failure factor information at regular intervals such as every day, every half day, and every week. The use situation prediction unit 102 may predict the use situation at a timing or frequency different from that of the acquisition unit 101.

Next, the determination unit 103 determines whether the use situation predicted in step S102 is the use situation that causes the failure factor included in the failure factor information (step S103).

When it is determined that the predicted use situation is a use situation that causes a failure factor (step S103: Yes), the notification unit 104 notifies of failure prediction information indicating that the occurrence of a failure is predicted (step S104).

When it is determined that the predicted use situation is not the use situation that causes the failure factor (step S103: No), the notification unit 104 notifies failure prediction information indicating that the occurrence of a failure has not been predicted (step S105). The operation in step S105 is an example of an operation in a case where it is determined that the predicted use situation is not the use situation that causes the failure factor (step S103: No). For example, in this case, the notification unit 104 may end the operation without sending a notification to the target device.

As described above, the information processing apparatus 100 ends a series of operations.

In the information processing apparatus according to the present example embodiment described above, the use situation prediction unit predicts the use situation of the target device of the same type as the device in which the failure has occurred, based on the information on the factor affecting the use situation of the target device. The determination unit determines whether the use situation predicted by the use situation prediction unit is a use situation that causes a failure factor. Then, the notification unit notifies the failure prediction information according to the determination result.

As a result, the information processing apparatus according to the present example embodiment can accurately predict a failure.

In particular, in a case where there is a change in the use situation, the information processing apparatus according to the present example embodiment can predict the occurrence of a failure after predicting the change in the use situation. For example, when a failure occurs in a certain device, the same failure may occur in other devices used in the same use situation. Even if the use situation is different at the time of performing the failure prediction, it can be said that the failure may occur in the future when the use situation becomes the same as the use situation of the device in which the failure occurs in the future. Therefore, since the information processing apparatus according to the present example embodiment predicts the use situation and predicts the failure based on the predicted use situation, it is possible to accurately predict the failure as compared with a case where the failure is predicted based on the past or current use situation.

### Second Example Embodiment

Next, a second example embodiment of the present disclosure will be described in detail with reference to the drawings. Hereinafter, description of contents overlapping with the above description will be omitted to the extent that the description of the present example embodiment is not unclear. In the second example embodiment, a case where an information processing apparatus 200 includes a failure factor identification unit 205 that identifies failure factor information will be described.

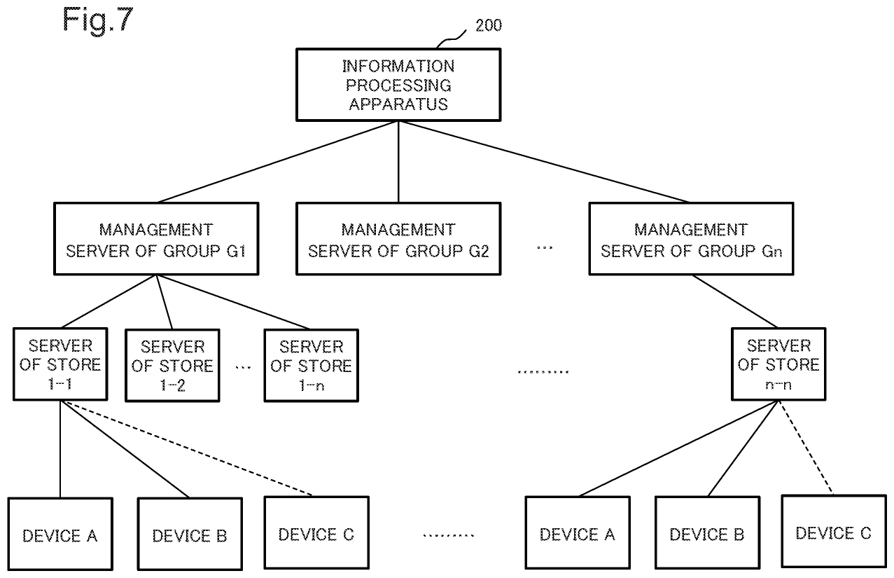

FIG. 7 is an example of a system including the information processing apparatus 200. The information processing apparatus 200 is communicably connected to the management server of a group G1, the management server of a group G2, . . . , and the management server of a group Gn. The management server of each group is a server that manages information on the device. The management server of each group is communicably connected to the computers or servers of the plurality of stores. The store's computer or server manages information on the store's devices. For example, in FIG. 7, the management server of the group G1 is communicably connected to the server of a store 1-1, the server of a store 1-2, . . . , and the server of a store 1-n. Further, a computer or a server of each store is communicably connected to a device provided in each store. Alternatively, a computer or a server of each store manages information of a device provided in each store. In this case, similarly to the device B1, the device B2, and the device B3 in FIG. 1, the device information may be input to the computer or the server by an administrator or the like of the device. Connection examples of the information processing apparatus 200, the management server of the group, the computer or server of the store, and the device are not limited to these examples. For example, the management server of the group may be directly communicably connected to the device, or the information of the device may be input by the administrator of the device. The information processing apparatus 200 is only required to be connected to each device so as to be able to collect the failure information and further notify the apparatus, the administrator or the like who manages the device of the prediction of the failure. Although not illustrated in FIG. 7, the information processing apparatus 200 may also be communicably connected to the failure factor information DB described in the first example embodiment to acquire the failure factor information.

Here, as described in the first example embodiment, the group is a group such as a company that manages a facility. In the example of FIG. 7, the group is a group such as a company that manages a plurality of stores.

For example, the information processing apparatus 200 manages various devices installed in each store of a convenience store. The convenience store is operated by a plurality of different companies. In the convenience store, the device is managed by the management server of each operating entity. Therefore, each management server that manages the convenience store is treated as a group. In this case, the information processing apparatus 200 collects information on devices of each convenience store company and manages the devices.

In the second example embodiment, in particular, a case where the information processing apparatus 200 generates failure factor information in addition to the failure prediction described in the first example embodiment, that is, a case where the information processing apparatus 200 specifies the factor of the failure will be described.

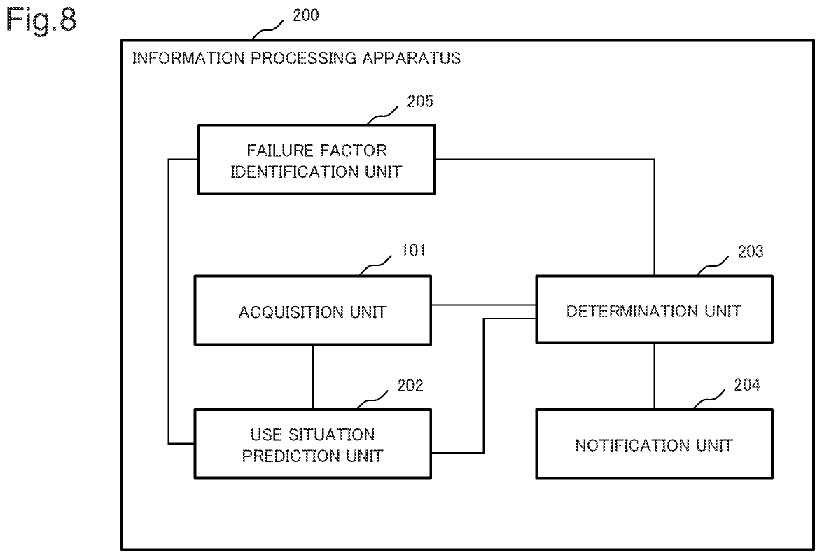

FIG. 8 is a block diagram illustrating a configuration of an information processing apparatus according to the second example embodiment of the present disclosure. The information processing apparatus 200 of the second example embodiment includes a failure factor identification unit 205 in addition to the configuration of the first example embodiment.

The failure factor identification unit 205 is an example of a failure factor identification means that identifies failure factor information based on failure information on a failure occurring in a device collected from a plurality of groups including a plurality of facilities. The failure information includes an occurrence date and time of a failure that has occurred, a failure content, a device in which the failure has occurred, and a use situation related to operation of the device. Here, the failure factor identification unit 205 may identify failure factor information. That is, even when the failure factor itself cannot be specified, the failure factor identification unit 205 may identify the attribute of the device that is considered to cause the failure factor and the use situation of the device based on the tendency of the information included in the failure information. For example, the failure factor identification unit 205 may identify information that tends to be frequently seen in failures included in the failure information as causing a failure factor. As an example, the failure factor identification unit 205 may identify information common to 80% or more of failures included in failure information as causing a failure factor. The method for identifying the failure factor is not limited to this example.

The attribute of the device may be a type of the device, a manufacturer, a series or a model number of the device, a lot number of the target device, or the like.

The failure factor identification unit 205 may identify the failure factor based on the failure information using a known method. Further, the failure factor identification unit 205 may identify a failure factor by using information on the group in addition to the known method. Specifically, the failure factor identification unit 205 may determine whether the factor of the failure is due to the use situation of each group or the attribute of the device itself based on the tendency of the failure occurrence for each group.

For example, in a case where the number of occurrences of a certain failure in the group is larger than the number of occurrences of the failure in other groups by a predetermined value or more, the failure factor identification unit 205 identifies, as the failure factor information, the use situation and the failure factor of the group in which the number of occurrences of the failure is larger by the predetermined value or more. In this case, the failure factor identification unit 205 first collects information indicating the number of occurrences of each failure from each group. The failure factor identification unit 205 may compare the number of occurrences of a failure in each group for each failure from the collected information indicating the number of occurrences of a failure in each group. The predetermined value may be a value set in advance. The number of occurrences of a failure may be a frequency of occurrence of a failure.

More specifically, the failure factor identification unit 205 identifies a use situation having a difference from the use situations of other groups among the use situations of the group in which the number of occurrences of a failure is greater than or equal to a predetermined value. Then, the failure factor identification unit 205 determines that the identified use situation causes a failure factor, and sets the failure factor information in association with the failure. On the other hand, when the difference in the number of occurrences of a certain failure for each group is less than the predetermined value, the failure factor identification unit 205 does not associate the use situation with the failure factor information of the device in which the failure occurs. In other words, in a case where the difference in the number of occurrences of a certain failure for each group is less than the predetermined value, the failure factor identification unit 205 may identify that the use situation or the attribute of the device common to all causes the failure factor instead of the use situation having a characteristic for each group.

As described above, in a case where the failure factor identification unit 205 identifies failure factor information by using a group, when failures frequently occur in the group, it can be assumed that there is a use situation that causes a failure factor in the use situation of the group. Therefore, by considering the use situation of the devices in the group, the failure factor identification unit 205 can reduce the failure information to be compared and efficiently identify the failure factor information. In a case where the failure factor identification unit 205 identifies failure factor information by using a group, when there is no difference in the number of occurrences of a failure for each group, there is no need to include information for identifying the group in the failure information, and there is an advantage that it is not necessary in the group to completely disclose the failure information of the group.

So far, in the second example embodiment, an example has been described in which the use situation of the group in which the number of occurrences of a failure is larger than the predetermined value causes the failure factor in the identification of the failure factor information using the group of the failure factor identification unit 205. On the other hand, the failure factor identification unit 205 may further identify the use situation of the group in which the number of occurrences of a failure is smaller than a predetermined value as the use situation for preventing the occurrence of a failure factor The use situation that prevents causing a failure factor may be stored in association with the failure as a countermeasure against the failure.

When predicting the use situation included in the failure factor information, a use situation prediction unit 202 may predict the use situation with reference to at least one of the failure factor information acquired by the acquisition unit 101 or the failure factor information specified by the failure factor identification unit 205.

Similarly, a determination unit 203 may determine whether the predicted use situation causes a failure factor with reference to at least one of the failure factor information acquired by the acquisition unit 101 and the failure factor information specified by the failure factor identification unit 205. When the use situation prediction unit 102 predicts the use situation included in the failure factor information, the determination unit 103 may determine whether the predicted use situation causes a failure factor by referring to the failure factor information referred to by the use situation prediction unit 102.

As in the first example embodiment, a notification unit 204 notifies the target device of failure prediction information indicating the possibility of occurrence of a failure according to the determination result. The notification unit 204 may notify the computers or servers of the store of the notification of FIGS. 4, 5, and the like described in the first example embodiment via the computer or server of the groups. The notification unit 204 may notify the device of the notification of FIGS. 4 and 5 described in the first example embodiment via the computer or server of the group and the computer or server of the store. Further, the notification unit 204 may notify the group of the failure prediction information.

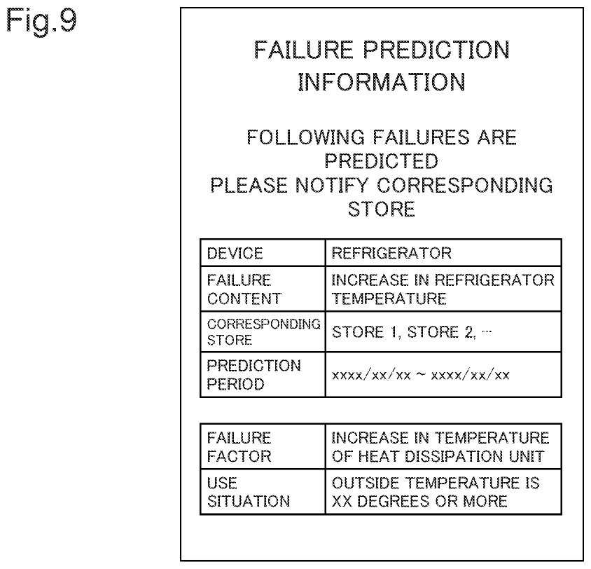

FIG. 9 is a notification example in a case where the notification unit 204 notifies the group of the failure prediction information. In FIG. 9, the notification made by the notification unit 204 to the computer or server of the group includes an instruction for the notified group to make a notification to the corresponding store of the failure prediction information. The computer or server of the group having received the notification of FIG. 9 may notify the computer or server of the corresponding store of the failure prediction information as illustrated in FIG. 4.

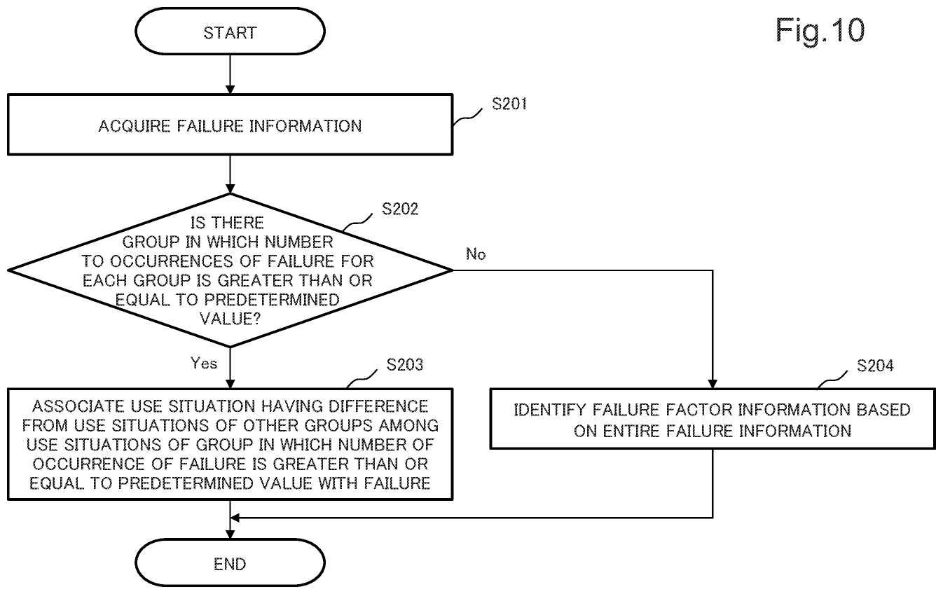

The operation of the information processing apparatus 200 configured as described above will be described with reference to the flowchart of FIG. 10.

FIG. 10 is a flowchart illustrating an operation related to specific processing of failure factor information among operations of the information processing apparatus 200 in the second example embodiment.

As illustrated in FIG. 10, first, the failure factor identification unit 205 collects failure information from each group (step S201).

Next, the failure factor identification unit 205 compares the number of occurrences of a failure in each group, and determines whether there is a group in which the number of occurrences of a certain failure in the group is larger than the number of occurrences of a failure in other groups by a predetermined value or more (step S202).

In a case where it is determined that there is a group in which the number of occurrences of a certain failure in the group is larger than the number of occurrences of a failure in the other group by a predetermined value or more (step S202: Yes), the failure factor identification unit 205 compares the use situation of each group related to the device included in the failure information, and identifies the use situation of the group in which the number of occurrences of the certain failure is larger than the predetermined value or more, which is different from the use situation in the other group, as the failure factor information in association with the content of the failure (step S203).

In a case where it is not determined that there is a group in which the number of occurrences of a certain failure in the group is larger than the number of occurrences of a failure in other groups by the predetermined value or more (step S202: No), the failure factor identification unit 205 identifies failure factor information using a known method based on the entire failure information (step S204). A case where it is not determined that there is a group in which the number of occurrences of a certain failure in the group is larger than the number of occurrences of a failure in other groups by a predetermined value or more (step S202: No) is a case where a difference in the number of occurrences of failures between the groups is less than a predetermined value.

As described above, the information processing apparatus 200 ends a series of operations related to the identification of the failure factor information. After these operations, the information processing apparatus 200 may perform the failure prediction operations in and after step S102 of the flowchart of FIG. 6 in the first example embodiment.

In the information processing apparatus according to the present example embodiment described above, the use situation prediction unit predicts the use situation of the target device of the same type as the device in which the failure has occurred, based on the information on the factor affecting the use situation of the target device. The determination unit determines whether the use situation predicted by the use situation prediction unit is a use situation that causes a failure factor. Then, the notification unit notifies the failure prediction information according to the determination result.

As a result, the information processing apparatus according to the present example embodiment can accurately predict a failure.

Furthermore, in the information processing apparatus according to the present example embodiment, the failure factor identification unit identifies failure factor information based on failure information on a failure that has occurred in a device, the failure information having been collected from a plurality of groups including a plurality of facilities. As a result, in a case where the number of occurrences of a failure in the group is characteristic, the information processing apparatus according to the present example embodiment can efficiently identify failure factor information used for failure prediction.

### [Hardware Configuration]

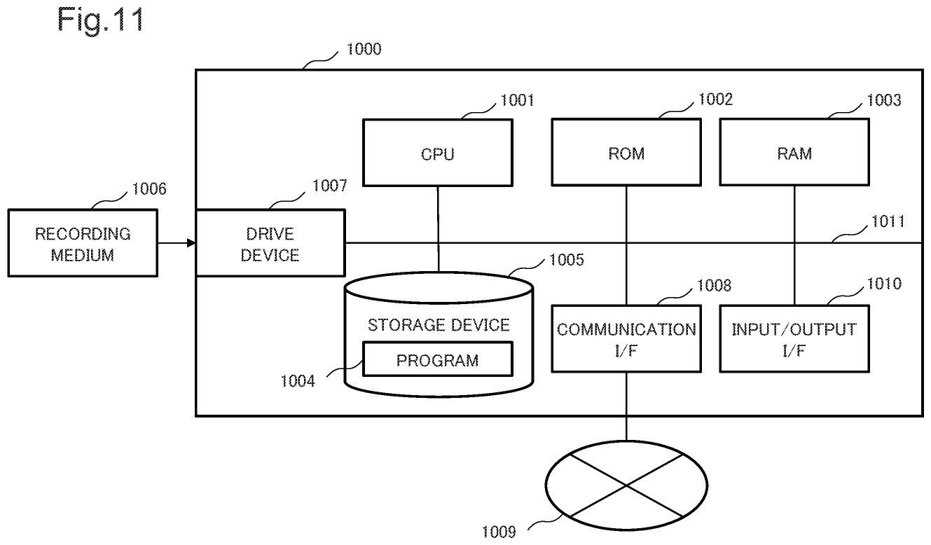

Apart or all of each component of each apparatus or system in each example embodiment of the present disclosure described above is achieved by, for example, any combination of the information processing apparatus 1000 and a program as illustrated in FIG. 11. As an example, an information processing apparatus 1000 includes the following configurations.
CPU (Central Processing Unit) 1001
ROM (Read Only Memory) 1002
RAM (Random Access Memory) 1003
Program 1004 loaded into RAM 1003
Storage device 1005 storing program 1004
Drive device 1007 for reading recording medium 1006
Communication I/F 1008 connected to communication network 1009
Input/output I/F 1010 for inputting/outputting data
Bus 1011 connecting each component
The I/F is an abbreviation of Interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the method of achieving each device. For example, each device or system may be achieved by any combination of the information processing apparatus 1000 and the program separate for each component. A plurality of components included in each device may be achieved by any combination of one information processing apparatus 1000 and a program.

Some or all of the components of each device or system are achieved by general-purpose or dedicated circuitry including a processor or the like, or a combination thereof. The circuit is, for example, a CPU, a graphics processing unit (GPU), a field programmable gate array (FPGA), or a large scale integration (LSI). The LSI is, for example, an LSI dedicated to artificial intelligence (AI) processing. These may be configured by a single chip or may be configured by a plurality of chips connected via a bus. Some or all of the components of each device may be achieved by a combination of the above-described circuit and the like and a program.

In a case where some or all of the components of each device or system are achieved by a plurality of information processing apparatuses, circuits, and the like, the plurality of information processing apparatuses, circuits, and the like may be arranged in a centralized manner or in a distributed manner. For example, the information processing apparatus, the circuit, and the like may be achieved as a form in which each is connected via a communication network, such as a client and server system or a cloud computing system.

In stores and factories, there are technologies that collect information on equipment failures, analyze failure factors based on the collected information, and predict the occurrence of failures.

However, the usage conditions of equipment used to predict failures may change from the current detected usage conditions. Therefore, if only fault occurrence is predicted based on the current usage status, the result of fault prediction may differ from the case where the usage status has changed. As a result, only predicting failures based on the current usage conditions may not be accurate in predicting equipment failures.

An example advantage according to this disclosure is that it can accurately predict a failure.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

It will be understood by those of ordinary skill in the art that various changes in form and details may be made therein without departing from the spirit and scope of the present disclosure as defined by the claims. For example, the information processing apparatus 200 according to the second example embodiment may be changed to an information processing apparatus that does not include the acquisition unit 101.

Although the plurality of operations are described in order in the form of a flowchart, the order of description does not limit the order of executing the plurality of operations. Therefore, when each example embodiment is implemented, the order of the plurality of operations may be changed within a range that does not interfere with the content.

Further, it is noted that the inventor's intent is to retain all equivalents of the claimed invention even if the claims are amended during prosecution.

### SUPPLEMENTARY NOTE

### Supplementary note 1

An information processing apparatus including:
an acquisition means that acquires failure factor information including a content of a failure that has occurred in a device, a failure factor of the failure, and a use situation of the device that causes the failure factor;
a use situation prediction means that predicts a use situation of a target device of a same type as the device installed in a facility based on information on a factor that affects a use situation of the target device;
a determination means that determines, based on the failure factor information, that the predicted use situation is a use situation that causes the failure factor; and
a notification means that notifies, according to a result of determination, failure prediction information indicating a possibility that a failure occurs in the target device.

### Supplementary Note 2

The information processing apparatus according to Supplementary note 1, in which
the use situation prediction means predicts a use situation included in the failure factor information among use situations of the target device.

### Supplementary Note 3

The information processing apparatus according to Supplementary note 1 or 2, in which
information on a factor affecting a use situation of the target device includes information on a facility in which the target device is installed.

### Supplementary Note 4

The information processing apparatus according to any one of Supplementary notes 1 to 3, in which
the failure factor information includes environment information indicating an environment in which the device is used as a use situation of the device that causes the failure factor,
information on a factor affecting a use situation of the target device is weather information of an area including a facility in which the target device is installed, and
the use situation prediction means predicts environment information of the target device among use situations of the target device based on the weather information.

### Supplementary Note 5

The information processing apparatus according to any one of Supplementary notes 1 to 4, in which
the failure factor information includes a number of times of use or a use amount of the device as a use situation of the device causing the failure factor,
information on a factor affecting a use situation of the target device is information indicating a sales prediction of the facility, and
the use situation prediction means predicts a number of times of use or a use amount of the target device among use situations of the target device based on information indicating a sales prediction of the facility.

### Supplementary Note 6

The information processing apparatus according to Supplementary note 5, in which
information on a factor affecting a use situation of the target device is sales data of the facility, and
the use situation prediction means generates information indicating a sales prediction of the facility based on the sales data, and predicts a number of times of use or a use amount of the target device based on the calculated information indicating the sales prediction of the facility.

### Supplementary Note 7

The information processing apparatus according to any one of Supplementary notes 1 to 6, further including:
a failure factor identification means that identifies the failure factor information based on failure information on a failure occurring in the device collected from a plurality of groups including a plurality of facilities, in which
in a case where the number of occurrences of a certain failure in a group is larger than the number of occurrences of the failure in other groups by a predetermined value or more, the failure factor identification means identifies, as the failure factor information, a use situation and a failure factor of a group in which the number of occurrences of the failure is larger by a predetermined value or more.

### Supplementary Note 8

The information processing apparatus according to Supplementary note 7, in which
the failure factor identification means sets, as the failure factor information, a use situation having a difference from a use situation of other groups among use situations of groups in which the number of occurrences of a failure is greater than or equal to a predetermined value, in association with the failure.

### Supplementary Note 9

The information processing apparatus according to Supplementary note 7 or 8, in which
in a case where a difference in the number of occurrences of a certain failure for each group is less than a predetermined value, the failure factor identification means does not associate a use situation with the failure factor information of a device in which the failure occurs.

### Supplementary Note 10

An information processing method causing a computer to execute:
acquiring failure factor information including a content of a failure that has occurred in a device, a failure factor of the failure, and a use situation of the device that causes the failure factor;
predicting a use situation of a target device of a same type as the device installed in a facility based on information on a factor that affects a use situation of the target device;
determining, based on the failure factor information, that the predicted use situation is a use situation that causes the failure factor; and
notifying, according to a result of determination, failure prediction information indicating a possibility that a failure occurs in the target device.

### Supplementary Note 11

A recording medium storing a program for causing a computer to execute processing of:
acquiring failure factor information including a content of a failure that has occurred in a device, a failure factor of the failure, and a use situation of the device that causes the failure factor;
predicting a use situation of a target device of a same type as the device installed in a facility based on information on a factor that affects a use situation of the target device;
determining, based on the failure factor information, that the predicted use situation is a use situation that causes the failure factor; and
notifying, according to a result of determination, failure prediction information indicating a possibility that a failure occurs in the target device.

1. An information processing apparatus comprising:
a memory storing instructions; and
one or more processors configured to execute the instructions to:
acquire failure factor information including a content of a failure that has occurred in a device, a failure factor of the failure, and a use situation of the device that causes the failure factor;
predict a use situation of a target device of a same type as the device installed in a facility based on information on a factor that affects a use situation of the target device;
determine, based on the failure factor information, that the predicted use situation is a use situation that causes the failure factor; and
notify, according to a result of determination, failure prediction information indicating a possibility that a failure occurs in the target device.

2. The information processing apparatus according to claim 1, wherein
the one or more processors are further configured to execute the instructions to:
predict a use situation included in the failure factor information among use situations of the target device.

3. The information processing apparatus according to claim 1,
wherein information on the factor that affects the use situation of the target device includes information on a facility in which the target device is installed.

4. The information processing apparatus according to claim 1,
wherein the failure factor information includes environment information indicating an environment in which the device is used as a use situation of the device causing the failure factor,
wherein information on a factor affecting a use situation of the target device is weather information of an area including a facility in which the target device is installed, and
wherein the one or more processors are further configured to execute the instructions to:
predict environment information of the target device among use situations of the target device based on the weather information.

5. The information processing apparatus according to claim 1,
wherein the failure factor information includes a number of times of use or a use amount of the device as a use situation of the device causing the failure factor,
wherein information on a factor that affects a use situation of the target device is information indicating a sales prediction of the facility, and
wherein the one or more processors are further configured to execute the instructions to:
predict a number of times of use or a use amount of the target device among use situations of the target device based on information indicating a sales prediction of the facility.

6. The information processing apparatus according to claim 5,
wherein information on a factor affecting a use situation of the target device is sales data of the facility, and
wherein the one or more processors are further configured to execute the instructions to:
generate, based on the sales data, information indicating a sales prediction of the facility; and
predict a number of times of use or a use amount of the target device based on calculated information indicating a sales prediction of the facility.

7. The information processing apparatus according to claim 1, wherein
the one or more processors are further configured to execute the instructions to:
specify the failure factor information based on failure information on a failure occurring in the device, the failure information being collected from a plurality of groups including a plurality of facilities; and
in a case where a number of occurrences of a certain failure in a group is larger than a number of occurrences of the failure in another group by a predetermined value or more, a use situation and a failure factor of the group in which the number of occurrences of the failure is larger by a predetermined value or more are specified as the failure factor information.

8. The information processing apparatus according to claim 7, wherein
the one or more processors are further configured to execute the instructions to:
among use situations of a group in which a number of occurrences of a failure is greater than or equal to a predetermined value, a use situation having a difference from use situations of other groups is set as the failure factor information in association with the failure.

9. The information processing apparatus according to claim 7, wherein
the one or more processors are further configured to execute the instructions to:
in a case where a difference in a number of occurrences of a certain failure for each group is less than a predetermined value, a use situation is not associated with the failure factor information of the device in which the failure occurs.

10. An information processing method by a computer, the information processing method comprising:
acquiring failure factor information including a content of a failure that has occurred in a device, a failure factor of the failure, and a use situation of the device that causes the failure factor;
predicting a use situation of a target device of a same type as the device installed in a facility based on information on a factor that affects a use situation of the target device;
determining, based on the failure factor information, that the predicted use situation is a use situation that causes the failure factor; and
notifying, according to a result of determination, failure prediction information indicating a possibility that a failure occurs in the target device.

11. A non-transitory computer-readable recording medium that records a program for causing a computer to execute:
acquiring failure factor information including a content of a failure that has occurred in a device, a failure factor of the failure, and a use situation of the device that causes the failure factor;
predicting a use situation of a target device of a same type as the device installed in a facility based on information on a factor that affects a use situation of the target device;
determining, based on the failure factor information, that the predicted use situation is a use situation that causes the failure factor; and
notifying, according to a result of determination, failure prediction information indicating a possibility that a failure occurs in the target device.
